(19) United States
(12) Patent Application Publication
(10) Pub. No.: US 2002/0070858 A1
(43) Pub. Date: Jun. 13, 2002

(54) Placement of camera in door for face recognition-based security systems

(75) Inventors: Srinivas Gutta, Buchanan, NY (US); Antonio Colmenarez JR., Peekskill, NY (US)

Correspondence Address: Jack E. Haken, c/o U. S. PHILIPS CORPORATION, Intellectual Property Department, 580 White Plains Road, Tarrytown, NY, 10591, US

(73) Assignee: Philips Electronics North America Corporation

(21) Appl. No.: 09/734,780

(22) Filed: Dec. 12, 2000

(51) Int. Cl. G08B 13/00

(52) U.S. Cl. 340/541; 340/545.1

(57) ABSTRACT

A security system including: a camera mounted to a door for capturing image data of an individual approaching the door; and a processor for further processing the image data. Preferably, the system includes: a database for storing the image data; and a recognition system for analyzing the stored image data. The stored image data in the database are preferably face images and the recognition system is preferably a face recognition system. The database can contain image data for each authorized individual of the structure where the recognition system compares images of the individual from the camera with the stored image data to determine if the individual is one of the authorized individuals. The system includes a sensor, operatively connected to the door knob of the door, for detecting the arrival of the individual approaching the door and signaling the camera to capture the image data of the individual upon operation of the door knob. The camera is preferably mounted above the door knob and directed upwards at an angle from the door to ensure a good face image of the individual. Also provided is a method for responding to an individual approaching the door of a structure. The method includes: providing a detector for detecting the individual interacting with the door; producing a signal in response to the individual interacting with the door; and triggering an event in response to the signal.

### BACKGROUND OF THE INVENTION

1. Field of the Invention

The present invention relates generally to security monitoring systems and, more particularly, to a security monitoring system having a camera placed in a door of a structure for face recognition-based security systems.

2. Prior Art

Security systems of the prior art, particularly residential security systems, are known to employ biometrics, specifically, face recognition, to detect the face of an approaching individual or for recognition of the individual. These types of security systems are also referred to as access control systems.

In most access control systems of the prior art, specifically those that employ face recognition, a pan-tilt-zoom (PTZ) camera or a static camera with a wide field of view (FOV) is placed on the ceiling inside a structure. The camera typically faces towards an entrance door for either detection of the face of an entering individual or for recognition of the individual's face. A problem associated with these prior art systems is that, even with a good FOV camera, the resolution might not be as good as is necessary to detect the face. Thus, the system is likely to fail in detecting the face as well as the eventual recognition of the face.

Still other access control systems of the prior art place the camera on top of the door for achieving the recognition. This system works well when the individual is walking towards the door. However, if the individual is approaching the door from the side, no frontal face would be recorded by the access control system. Furthermore, when approaching from the side, the individual is exposed to the camera for a shorter time. If the time the individual is exposed to the camera is too short, e.g., less then a second, the system may not have sufficient time to detect and recognize the individual.

Furthermore, in the prior art systems, the individual having his or her face recognized needs to cooperate with the system, in other words, the individual must stand in front of the camera so as to enable the system to detect their face. Therefore, those who do not wish for their face to be detected easily avoid the systems of the prior art.

In view of the prior art, there is a need for a security/access control system employing face recognition which is easier and more likely to capture a full frontal face of an entering or exiting person for detection as well as recognition of the individual.

### SUMMARY OF THE INVENTION

Therefore it is an object of the present invention to provide a security/access control system which employs biometrics and is more likely to detect and recognize an approaching individual than the systems of the prior art.

It is a further object of the present invention to provide a security/access control system which employs face recognition and which is easier and more likely to capture a full frontal face of an entering or exiting person for recognition of the individual.

It is still a further object of the present invention to provide a security/access control system, which employs face recognition that makes it difficult for an individual to avoid having his or her face being recognized.

Accordingly, a security system is provided. The security system comprises: at least one camera mounted to a door of a structure for capturing image data of an individual approaching the door; and processing means for further processing the image data. Preferably, the security system further comprises: a database for storing the image data; and a recognition system for analyzing the stored image data. The stored image data in the database is typically face images where the recognition system is a face recognition system in which case the database can further contain image data for each authorized individual of the structure and the recognition system can compare images of the individual from the at least one camera with the stored image data in the database and for determining if the individual is one of the authorized individuals. If the individual is determined not to be one of the authorized individuals, the processing means, preferably in the form of an alarm system, can transmit an alarm signal and/or the image data, preferably, to a central monitoring site. Alternatively, the system can transmit the image data without further processing to a central monitoring site for purposes of logging the individuals who enter/leave the structure.

In a preferred implementation of the security system of the present invention, the security system further comprises a detection means for detecting the arrival of the individual approaching the door and signaling the at least one camera to capture the image data of the individual. The detection means preferably comprises a sensor operatively connected to a door knob on the door, such that operation of the door knob signals the at least one camera to capture the image data of the individual. The at least one camera is preferably mounted to the door in proximity to a door knob on the door and more preferably the at least one camera is mounted above the door knob and directed upwards at an angle from a surface of the door.

In a variation of the preferred implementation of the security system of the present invention, the at least one camera comprises a first and second camera. The first camera is preferably mounted on a first side of the door in proximity to a door knob on the door, and the second camera is preferably mounted on a second side in proximity to the door knob on the door. More preferably, the first and second cameras are each mounted above the door knob and directed upwards at an angle from their respective side of the door. The variation of the preferred implementation preferably further comprises a detection means for detecting the arrival of the individual approaching the door and signaling one of the first or second cameras to capture the image data of the individual approaching the door. The detection means preferably comprises first and second sensors operatively connected to the door knob, such that operation of the door knob from the first side operates the first sensor to signal the first camera to capture the image data of the individual approaching from the first side and operation of the door knob from a second side operates the second sensor to signal the second camera to capture the image data of the individual approaching from the second side.

Also provided is a method for responding to an individual approaching a door of a structure. The method comprises the steps of: providing a means for detecting the individual interacting with the door; producing a signal in response to the individual interacting with the door; and triggering an event in response to the signal. The event is preferably an instruction to a camera to capture image data of the individual.

Still yet provided is a system for responding to an individual approaching a door of a structure. The system comprises: means for detecting the individual interacting with the door; means for producing a signal in response to the individual interacting with the door; and means for triggering an event in response to the signal. The means for detecting is preferably either a sensor operatively connected to the door knob of the door and the signal is produced upon the operation of the door knob or a recognition system for detecting changes in the background near the door. The system preferably further comprises a camera, preferably mounted to the door, wherein the event is preferably an instruction to the camera to capture image data of the individual.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematical view of the security/access control system of the present invention.

FIG. 2 illustrates a partial sectional view of a first variation of door mounted camera taken along line 2-2 of FIG. 1.

FIG. 3 illustrates a partial sectional view of a second variation of door mounted camera as it would appear if taken along line 2-2 of FIG. 1.

### DETAILED DESCRIPTION OF THE PREFERRED EMBODIMENT

Although this invention is applicable to numerous and various types of security systems, it has been found particularly useful in the environment of residential security systems and face recognition. Therefore, without limiting the applicability of the invention to residential security systems and face recognition, the invention will be described in such environment.

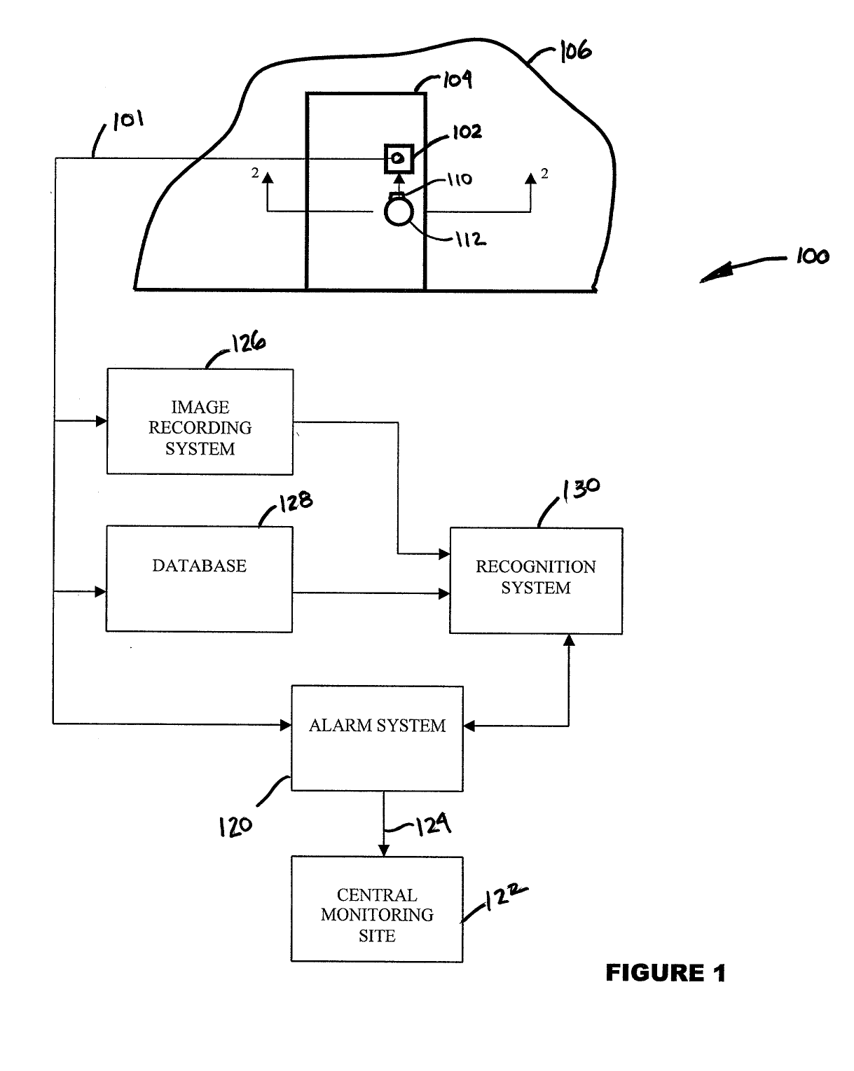

Referring now to FIG. 1, there is illustrated a schematical representation of a preferred implementation of the security system of the present invention, generally referred to by reference numeral 100. The system 100 is described as a security system, however, the term “security” is intended to incorporate not only a system which triggers an alarm in response to an unauthorized intruder into a structure, but also security systems which detect individuals entering or leaving a structure and recognizes, classifies, and/or logs the individuals.

The system 100 generally comprises a camera 102 mounted to a door 104 of a structure 106 for capturing image data of an individual approaching the door 104. The camera can be a black and white or color camera. The camera can further be a pan-tilt-zoom (PTZ) camera or a stationary camera with a wide enough field of view (FOV) to appropriately capture the intended features, e.g., the face, of the approaching individual.

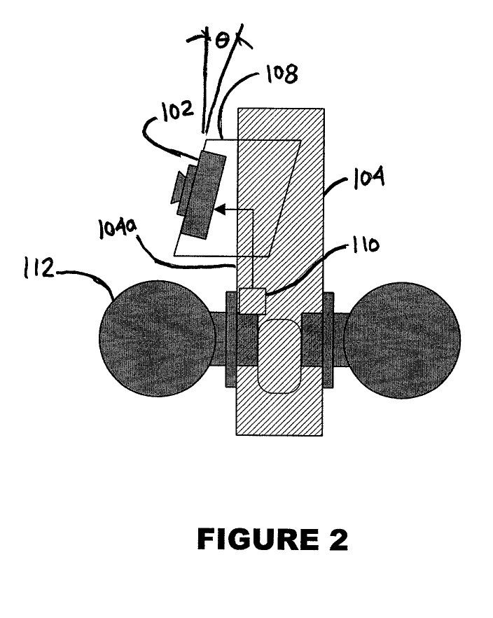

Referring now to FIG. 2, there is illustrated the camera 102 of FIG. 1. The camera 102 is preferably mounted to the door 104 in a suitable housing 108. The camera 102 could be wired or wireless with respect to both power as well as transmission of image data taken thereby. In the case of wireless transmission, a standard wireless protocol is preferably used, such as PNA1, PNA2, or Bluetooth protocols for residential wireless transmissions. The camera 102 is preferably battery operated and transmits the image data through a wireless link (shown schematically as link 101 in FIG. 1).

The system 100 also preferably includes a detection means for detecting the arrival of the individual approaching the door 104 and signaling the camera 102 to capture the image data of the approaching individual. The detection means preferably comprises a sensor 110 which detects the interaction of the approaching individual with the door. The sensor 100 is preferably operatively connected to a door knob 112 on the door 104. Upon operation of the door knob 112, the sensor 110 signals the camera 102 to capture the image data of the individual. The sensors can be of any type now known or later developed in the art, such as a contact switch, heat sensor, or magnetic sensor. Thus, the sensor 110 can be of a type which detects the turning of a door-knob, the depressing of a door-knob lever or the insertion of something into the keyhole of the door-knob, such as a key, all of which are referred to herein as an “interaction” with the door 104. Therefore, when the individual interacts with the door 104 to operate the door knob 112 by touching it, trying to open it, or by inserting anything into the keyhole, such as a key, it can be assumed that he or she is trying to open the door 104.

Still yet another means for detecting the approaching individual is to use a recognition system 130 which uses a background learning model. When nobody is present, image data is accumulated to learn the characteristic features (e.g., color distribution) of the background near the door 104. When the approaching individual comes in the camera's 102 field of view, the description will change. The learned model could then be used to classify each pixel as that belonging to either the background or the foreground. Such background learning model techniques are known in the art, such as that disclosed in, “Yogesh Raja, Stephen J. McKenna and Shaogang Gong, Segmentation and Tracking Using Colour Mixture Models, 3^{rd} Asian Conference on Computer Vision, Vol. 1, pp. 607-614, Hong Kong, China, January 1998”.

When opening a door, an individual always consciously or sub-consciously looks at either the door knob or a key hole on or near the door knob 112. As shown in FIG. 2, the camera 102 is preferably mounted to the door 104 in proximity to the door knob 112. More preferably, the camera 102 is mounted above the door knob 112 and directed upwards at an angle 2 from a surface 104a of the door. Thus, the camera 102 so configured and positioned is assured of a good view of the face of the individual approaching the door 104. As discussed above, the term “door knob” is intended to mean any device used to open and close a door and is not intended to be limited to a round knob type door knob which is rotated, but also other types of “door knobs” known in the art such as levers and the like. As also discussed above, the phrase “interaction with the door” is also used herein generally and is intended to generally describe accessing the door knob such as to touch the door knob, open and close the door (such as by rotation of the door knob or by depressing a lever on the door knob), or by inserting something into the door knob.

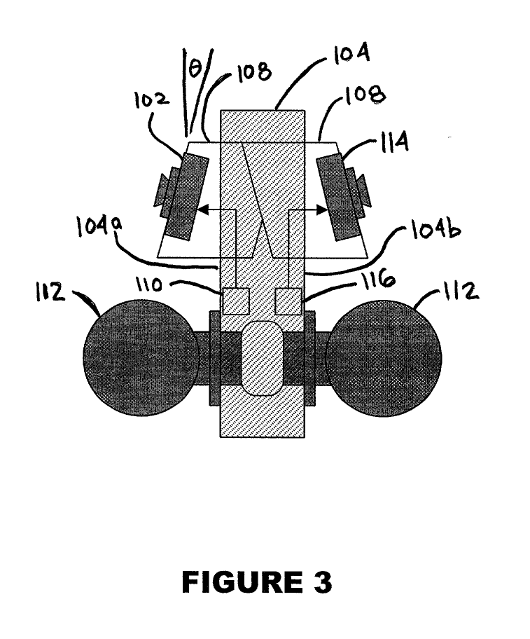

Referring now to FIG. 3, there is illustrated a variation of the door 104 and camera 102 configuration of FIG. 2. In some circumstances it may be advantageous to detect an individual approaching the door 104 from either an exterior side or an interior side. In other words, it may be necessary to detect an individual both entering and leaving a structure through an entry door. Such is the case in a security monitoring system as is disclosed in co-pending application Ser. No. _______ (Attorney docket number 701663, 13936) which is incorporated herein by its reference. In the variation of the security system 100 illustrated in FIG. 3, first and second cameras 102, 114 are provided on the door 104. Each camera 102, 114 being mounted in an appropriate housing 108 and preferably configured and positioned as discussed above with regard to FIG. 2. The first camera 102 is mounted on a first side 104a of the door in proximity to the door knob 112, and the second camera 114 is mounted on a second side 104b in proximity to the door knob 112. Both cameras 102, 114 are provided with a detection means, such as first and second sensors 110, 116, respectively, for detecting the arrival of the individual approaching the door 104 and signaling one of the first or second cameras 102, 114 to capture the image data of the individual approaching the door.

The first and second sensors 110, 116 are operatively connected to the door knob 112, such that interaction with the door 104 from the first side 104a, such as by operating the door knob 112, operates the first sensor 110 to signal the first camera 102 to capture the image data of the individual approaching from the first side 104a and interaction with the door 104 from a second side 104b, such as by operating the door knob 112, operates the second sensor 116 to signal the second camera 114 to capture the image data of the individual approaching from the second side 104b.

Referring back to FIG. 1, the system 100 of the present invention further includes processing means for further processing the image data or means for triggering an event based on the detection of the approaching individual. The processing means can be an alarm system 120 which merely transmits an alarm signal to a central monitoring site 122 upon the activation of the sensor(s) 110 (116) via a data link such as a telephone line (POTS) shown schematically as link 124. The alarm system 120 can also transmit the image data to the central monitoring site 122 without further processing to log the image data. Alternatively, the alarm system 120 can sound an alarm and/or transmit the alarm signal to the central monitoring site 122. The triggering of an event can be the instruction of the camera(s) 102, 114 to capture the image data or simply turning the lights on in the structure 106. Those skilled in the art will realize that these events are given by way of illustration only and not to limit the scope or spirit of the invention.

The system 100 preferably further comprises an image recording system 126 for recording the captured image data from the camera 102, 114 and a database 128 for storing the image data, such as face images. A recognition system 130, such as a face recognition system can then be utilized to analyze the stored image data. The database 128 preferably contains image data for each authorized individual of the structure 106 and the recognition system 130 compares images of the approaching individual from the camera(s) 102 (114) with the stored image data in the database 128 and determines if the approaching individual is one of the authorized individuals. In such a configuration, the processing means preferably comprises the alarm system 120 which transmits an alarm signal and/or the image data if the approaching individual is determined not to be one of the authorized individuals. Face recognition algorithms and systems are well known in the art, such as the one described in S. Gutta et al., Face Recognition, Sixth International Conference on Computer Vision, pgs. 646-651, IEEE, Jan. 4-7, 1998, Mumbai, India.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A security system comprising:
at least one camera mounted to a door of a structure for capturing image data of an individual approaching the door; and
processing means for further processing the image data.

2. The security system of claim 1, further comprising:
a database for storing the image data; and
a recognition system for analyzing the stored image data.

3. The security system of claim 2, wherein the stored image data in the database are face images and the recognition system is a face recognition system.

4. The security system of claim 2, wherein the database further contains image data for each authorized individual of the structure and the recognition system compares images of the individual from the at least one camera with the stored image data in the database and for determining if the individual is one of the authorized individuals.

5. The security system of claim 4, wherein the processing means comprises an alarm system which transmits an alarm signal if the individual is determined not to be one of the authorized individuals.

6. The security system of claim 5, wherein the alarm system transmits the alarm signal to a central monitoring site.

7. The security system of claim 6, wherein the alarm system further transmits the image data to the central monitoring site.

8. The security system of claim 1, wherein the processing means transmits the image data without further processing to a central monitoring site.

9. The security system of claim 1, further comprising a detection means for detecting the arrival of the individual approaching the door and signaling the at least one camera to capture the image data of the individual.

10. The security system of claim 9, wherein the detection means comprises a sensor operatively connected to a door knob on the door, such that operation of the door knob signals the at least one camera to capture the image data of the individual.

11. The security system of claim 9, wherein the detection means is a recognition system for detecting a change in the background near the door.

12. The security system of claim 1, wherein the at least one camera is mounted to the door in proximity to a door knob on the door.

13. The security system of claim 12, wherein the at least one camera is mounted above the door knob and directed upwards at an angle from a surface of the door.

14. The security system of claim 1, wherein the at least one camera comprises a first and second camera, the first camera being mounted on a first side of the door in proximity to a door knob on the door, and the second camera being mounted on a second side in proximity to the door knob on the door.

15. The security system of claim 14, wherein the first and second cameras are each mounted above the door knob and directed upwards at an angle from their respective side of the door.

16. The security system of claim 14, further comprising a detection means for detecting the arrival of the individual approaching the door and signaling one of the first or second cameras to capture the image data of the individual approaching the door.

17. The security system of claim 16, wherein the detection means comprises first and second sensors operatively connected to the door knob, such that operation of the door knob from the first side operates the first sensor to signal the first camera to capture the image data of the individual approaching from the first side and operation of the door knob from a second side operates the second sensor to signal the second camera to capture the image data of the individual approaching from the second side.

18. The security system of claim 1, wherein the at least one camera is battery operated and transmits the image data to the processing means through a wireless link.

19. A method for responding to an individual approaching a door of a structure, the method comprising the steps of:
providing a means for detecting the individual interacting with the door;
producing a signal in response to the individual interacting with the door; and
triggering an event in response to the signal.

20. The method of claim 19, wherein the event is an instruction to a camera to capture image data of the individual.

21. A system for responding to an individual approaching a door of a structure, the system comprising:
means for detecting the individual interacting with the door;
means for producing a signal in response to the individual interacting with the door; and
means for triggering an event in response to the signal.

22. The system of claim 21, wherein the means for detecting is a sensor operatively connected to the door knob of the door and the signal is produced upon the operation of the door knob.

23. The system of claim 21, further comprising a recognition system for detecting a change in the background near the door.

24. The system of claim 21, further comprising a camera, wherein the event is an instruction to the camera to capture image data of the individual.
